(19) United States
(12) Patent Application Publication
(10) Pub. No.: US 2024/0291543 A1
(43) Pub. Date: Aug. 29, 2024

(54) TRANSMISSION CONFIGURATION INDICATORS AND PRECODING MATRICES FOR MULTIPLE TRANSMISSIONS

(71) Applicant: QUALCOMM Incorporated, San Diego, CA (US)

(72) Inventors: Ahmed Elshafie, San Diego, CA (US); Diana Maamari, San Diego, CA (US); Yan Zhou, San Diego, CA (US); Huilin Xu, Temecula, CA (US); Ahmed Attia Abotabl, San Diego, CA (US); Marwen Zorgui, San Diego, CA (US)

(21) Appl. No.: 18/174,805

(22) Filed: Feb. 27, 2023

(51) Int. Cl. H04B 7/06; H04L 5/00; H04W 72/20

(52) U.S. Cl. CPC H04B 7/0639; H04L 5/0053; H04W 72/20

(57) ABSTRACT

Methods, systems, and devices for wireless communications are described. A user equipment (UE) may receive a control message scheduling a burst of downlink messages. The control message may indicate first and second pluralities of transmission configuration indicators associated with first and second downlink shared channels, respectively. The UE may monitor for a first and second downlink messages in the first downlink shared channel and the second downlink shared channel, using first and second transmission configuration indicators, respectively. Additionally, or alternatively, the UE may receive a control message scheduling a burst of uplink messages. The single control message may indicate to apply a first precoding matrix for transmission of the uplink messages. The UE may precode, using a second precoding matrix, an uplink message to generate a precoded first uplink message. The UE may transmit the precoded uplink message in a first uplink shared channel.

### FIELD OF TECHNOLOGY

The present disclosure relates to wireless communications, including transmission configuration indicators and precoding matrices for multiple transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may transmit a burst of transmissions or packets. However, such approaches may be improved.

### SUMMARY

The described techniques relate to improved methods, systems, devices, and apparatuses that support transmission configuration indicators and precoding matrices for multiple transmissions. A user equipment (UE) may receive a single control message scheduling a transmission burst comprising a plurality of downlink messages communicated in a plurality of downlink shared channels, the single control message indicating a first plurality of transmission configuration indicators associated with a first downlink shared channel of the plurality of downlink shared channels and a second plurality of transmission configuration indicators associated with a second downlink shared channel of the plurality of downlink shared channels. The UE may monitor for a first downlink message of the plurality of downlink messages in the first downlink shared channel using a first transmission configuration indicator selected from the first plurality of transmission configuration indicators. The UE may monitor for a second downlink message of the plurality of downlink messages in the second downlink shared channel using a second transmission configuration indicator selected from the second plurality of transmission configuration indicators.

A method for wireless communications at a user equipment (UE) is described. The method may include receiving a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels, monitoring for a first downlink message of the set of multiple downlink messages in the first downlink shared channel using a first transmission configuration indicator selected from the first set of multiple transmission configuration indicators, and monitoring for a second downlink message of the set of multiple downlink messages in the second downlink shared channel using a second transmission configuration indicator selected from the second set of multiple transmission configuration indicators.

An apparatus for wireless communications at a UE is described. The apparatus may include a processor, memory coupled with the processor, and instructions stored in the memory. The instructions may be executable by the processor to cause the apparatus to receive a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels, monitor for a first downlink message of the set of multiple downlink messages in the first downlink shared channel using a first transmission configuration indicator selected from the first set of multiple transmission configuration indicators, and monitor for a second downlink message of the set of multiple downlink messages in the second downlink shared channel using a second transmission configuration indicator selected from the second set of multiple transmission configuration indicators.

Another apparatus for wireless communications at a UE is described. The apparatus may include means for receiving a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels, means for monitoring for a first downlink message of the set of multiple downlink messages in the first downlink shared channel using a first transmission configuration indicator selected from the first set of multiple transmission configuration indicators, and means for monitoring for a second downlink message of the set of multiple downlink messages in the second downlink shared channel using a second transmission configuration indicator selected from the second set of multiple transmission configuration indicators.

A non-transitory computer-readable medium storing code for wireless communications at a UE is described. The code may include instructions executable by a processor to receive a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels, monitor for a first downlink message of the set of multiple downlink messages in the first downlink shared channel using a first transmission configuration indicator selected from the first set of multiple transmission configuration indicators, and monitor for a second downlink message of the set of multiple downlink messages in the second downlink shared channel using a second transmission configuration indicator selected from the second set of multiple transmission configuration indicators.

Some examples of the method, apparatuses, and non-transitory computer-readable medium described herein may further include operations, features, means, or instructions for monitoring the first downlink shared channel or a first control channel associated with the first downlink shared channel to determine a first channel quality metric, monitoring the second downlink shared channel or a second control channel associated with the second downlink shared channel to determine a second channel quality metric, and where the first transmission configuration indicator may be selected for the first downlink shared channel based on the first channel quality metric, and where the second transmission configuration indicator may be selected for the second downlink shared channel based on the second channel quality metric.

Some examples of the method, apparatuses, and non-transitory computer-readable medium described herein may further include operations, features, means, or instructions for receiving a second control message indicating that the UE may be to use the second transmission configuration indicator to monitor for the second downlink message and where the second downlink shared channel may be monitored using the second transmission configuration indicator based on the second control message.

Some examples of the method, apparatuses, and non-transitory computer-readable medium described herein may further include operations, features, means, or instructions for transmitting one or more negative acknowledgement messages associated with failure to receive the first downlink message via the first downlink shared channel and receiving, based on transmitting the one or more negative acknowledgement messages, a second control message indicating that the UE may be to monitor for the second downlink message in the second downlink shared channel using the second transmission configuration indicator.

Some examples of the method, apparatuses, and non-transitory computer-readable medium described herein may further include operations, features, means, or instructions for transmitting one or more negative acknowledgement messages associated with failure to receive the first downlink message via the first downlink shared channel and monitoring for the second downlink message in the second downlink shared channel using the second transmission configuration indicator based on a quantity of the one or more negative acknowledgement messages being greater than or equal to a negative acknowledgement message quantity threshold.

Some examples of the method, apparatuses, and non-transitory computer-readable medium described herein may further include operations, features, means, or instructions for receiving the single control message indicating a first feedback offset value and a second feedback offset value and where the first downlink shared channel may be monitored using the first transmission configuration indicator based on the first feedback offset value, and where the second downlink shared channel may be monitored using the second transmission configuration indicator based on the second feedback offset value.

A method for wireless communications at a UE is described. The method may include receiving a single control message scheduling a transmission burst including a set of multiple uplink messages communicated in a set of multiple uplink shared channels, the single control message indicating to apply a first precoding matrix for transmission of the set of multiple uplink messages, precoding, using a second precoding matrix that is different than the first precoding matrix, a first uplink message of the set of multiple uplink messages to generate a precoded first uplink message, and transmitting the precoded first uplink message in a first uplink shared channel of the set of multiple uplink shared channels.

An apparatus for wireless communications at a UE is described. The apparatus may include a processor, memory coupled with the processor, and instructions stored in the memory. The instructions may be executable by the processor to cause the apparatus to receive a single control message scheduling a transmission burst including a set of multiple uplink messages communicated in a set of multiple uplink shared channels, the single control message indicating to apply a first precoding matrix for transmission of the set of multiple uplink messages, precode, using a second precoding matrix that is different than the first precoding matrix, a first uplink message of the set of multiple uplink messages to generate a precoded first uplink message, and transmit the precoded first uplink message in a first uplink shared channel of the set of multiple uplink shared channels.

Another apparatus for wireless communications at a UE is described. The apparatus may include means for receiving a single control message scheduling a transmission burst including a set of multiple uplink messages communicated in a set of multiple uplink shared channels, the single control message indicating to apply a first precoding matrix for transmission of the set of multiple uplink messages, means for precoding, using a second precoding matrix that is different than the first precoding matrix, a first uplink message of the set of multiple uplink messages to generate a precoded first uplink message, and means for transmitting the precoded first uplink message in a first uplink shared channel of the set of multiple uplink shared channels.

A non-transitory computer-readable medium storing code for wireless communications at a UE is described. The code may include instructions executable by a processor to receive a single control message scheduling a transmission burst including a set of multiple uplink messages communicated in a set of multiple uplink shared channels, the single control message indicating to apply a first precoding matrix for transmission of the set of multiple uplink messages, precode, using a second precoding matrix that is different than the first precoding matrix, a first uplink message of the set of multiple uplink messages to generate a precoded first uplink message, and transmit the precoded first uplink message in a first uplink shared channel of the set of multiple uplink shared channels.

Some examples of the method, apparatuses, and non-transitory computer-readable medium described herein may further include operations, features, means, or instructions for precoding the first uplink message using the second precoding matrix based on an expiry of a timer relative to receipt of the single control message.

Some examples of the method, apparatuses, and non-transitory computer-readable medium described herein may further include operations, features, means, or instructions for receiving a second control message indicating a time threshold at which the timer may be to expire.

Some examples of the method, apparatuses, and non-transitory computer-readable medium described herein may further include operations, features, means, or instructions for starting the timer at a first time corresponding with a first slot of a first-in-time uplink message of the set of multiple uplink messages or at a second time corresponding to a beginning of connected mode discontinuous reception operation of the UE.

Some examples of the method, apparatuses, and non-transitory computer-readable medium described herein may further include operations, features, means, or instructions for receiving a set of multiple negative acknowledgement messages associated with one or more uplink messages of the set of multiple uplink messages and precoding the first uplink message using the second precoding matrix based on a quantity of the set of multiple negative acknowledgement messages being greater than or equal to a negative acknowledgement message quantity threshold.

Some examples of the method, apparatuses, and non-transitory computer-readable medium described herein may further include operations, features, means, or instructions for receiving a second control message indicating the negative acknowledgement message quantity threshold.

Some examples of the method, apparatuses, and non-transitory computer-readable medium described herein may further include operations, features, means, or instructions for transmitting an uplink control message indicating that the first uplink message may be to be precoded using the second precoding matrix.

Some examples of the method, apparatuses, and non-transitory computer-readable medium described herein may further include operations, features, means, or instructions for transmitting the precoded first uplink message using a first transmission configuration indicator based on one or more indications of channel quality of the first uplink shared channel.

In some examples of the method, apparatuses, and non-transitory computer-readable medium described herein, the uplink control message may be multiplexed with an uplink message of the set of multiple uplink messages.

In some examples of the method, apparatuses, and non-transitory computer-readable medium described herein, the second precoding matrix may be selected from a set of multiple precoding matrices permitted to be used by the UE.

### BRIEF DESCRIPTION OF THE DRAWINGS

FIG. 1 illustrates an example of a wireless communications system that supports transmission configuration indicators and precoding matrices for multiple transmissions in accordance with one or more examples as disclosed herein.

FIG. 2 illustrates an example of a wireless communications system that supports transmission configuration indicators and precoding matrices for multiple transmissions in accordance with one or more examples as disclosed herein.

FIGS. 3A, 3B, and 3C illustrate examples of downlink transmission schemes that support transmission configuration indicators and precoding matrices for multiple transmissions in accordance with one or more examples as disclosed herein.

FIG. 4 illustrates an example of a wireless communications system that supports transmission configuration indicators and precoding matrices for multiple transmissions in accordance with one or more examples as disclosed herein.

FIGS. 5A, 5B, and 5C illustrate examples of uplink transmission schemes that support transmission configuration indicators and precoding matrices for multiple transmissions in accordance with one or more examples as disclosed herein.

FIG. 6 illustrates an example of a process flow that supports transmission configuration indicators and precoding matrices for multiple transmissions in accordance with one or more examples as disclosed herein.

FIG. 7 illustrates an example of a process flow that supports transmission configuration indicators and precoding matrices for multiple transmissions in accordance with one or more examples as disclosed herein.

FIGS. 8 and 9 illustrate block diagrams of devices that support transmission configuration indicators and precoding matrices for multiple transmissions in accordance with one or more examples as disclosed herein.

FIG. 10 illustrates a block diagram of a communications manager that supports transmission configuration indicators and precoding matrices for multiple transmissions in accordance with one or more examples as disclosed herein.

FIG. 11 illustrates a diagram of a system including a device that supports transmission configuration indicators and precoding matrices for multiple transmissions in accordance with one or more examples as disclosed herein.

FIGS. 12 and 13 illustrate flowcharts showing methods that support transmission configuration indicators and precoding matrices for multiple transmissions in accordance with one or more examples as disclosed herein.

### DETAILED DESCRIPTION

Some wireless communications involve bursts of packets made in transmissions, such as in communications associated with extended reality, augmented reality, or virtual reality. To implement such “bursty” transmissions, multiple downlink shared channel transmissions may be scheduled by a single downlink control information (DCI) transmission to reduce control signaling overhead. As such, a single parameter or field may apply to the multiple downlink shared channel transmissions. For example, a single transmissions configuration indication (TCI) field may designate a single TCI state for the multiple downlink shared channel transmissions. However, such a TCI may be suboptimal for some of the downlink shared channel transmissions, which may decrease reliability. Similar issues may also be present for uplink transmissions, in that a single precoding matrix may be indicated for use for a burst of uplink transmissions wherein such a precoding matrix may be suboptimal for some of the uplink shared channel transmissions.

For downlink burst transmissions, the UE may receive multiple options for TCI states for receiving multiple scheduled downlink shared channel transmissions and may select one of the TCI states for receiving a respective one of the multiple downlink shared channel transmissions. The UE may select the TCI states based on one or more factors, such as channel quality metrics, a quantity of negative acknowledgement (NACK) messages received, or a quantity of offset values received in control signaling. Similarly, for uplink bursts, the UE may receive an initial indication of a first precoding matrix to use for transmitting the uplink messages but may instead transmit an uplink transmission using a second, different, precoding matrix. The second precoding matrix may be used after a threshold amount of time has passed or after receiving a quantity of NACKs. In some examples, the UE may indicate (e.g., to a network entity) the second precoding matrix or may select from a set of precoding matrices (e.g., a restricted set of precoding matrices, such as precoding matrices of which a network entity may already be aware).

In this way, reliability of burst transmissions (e.g., uplink, downlink, sidelink, or any combination thereof) may be improved, as TCI states, precoding matrices, or both, may be used on a per-transmission basis (e.g., instead of a per-burst basis) and different TCI states, precoding matrices, or both may be tailored or selected based on different characteristics of different transmissions.

Aspects of the disclosure are initially described in the context of wireless communications systems. Aspects of the disclosure are then described with reference to a wireless communications system, downlink transmission schemes, another wireless communications system, uplink transmission schemes, and process flows. Aspects of the disclosure are further illustrated by and described with reference to apparatus diagrams, system diagrams, and flowcharts that relate to transmission configuration indicators and precoding matrices for multiple transmissions.

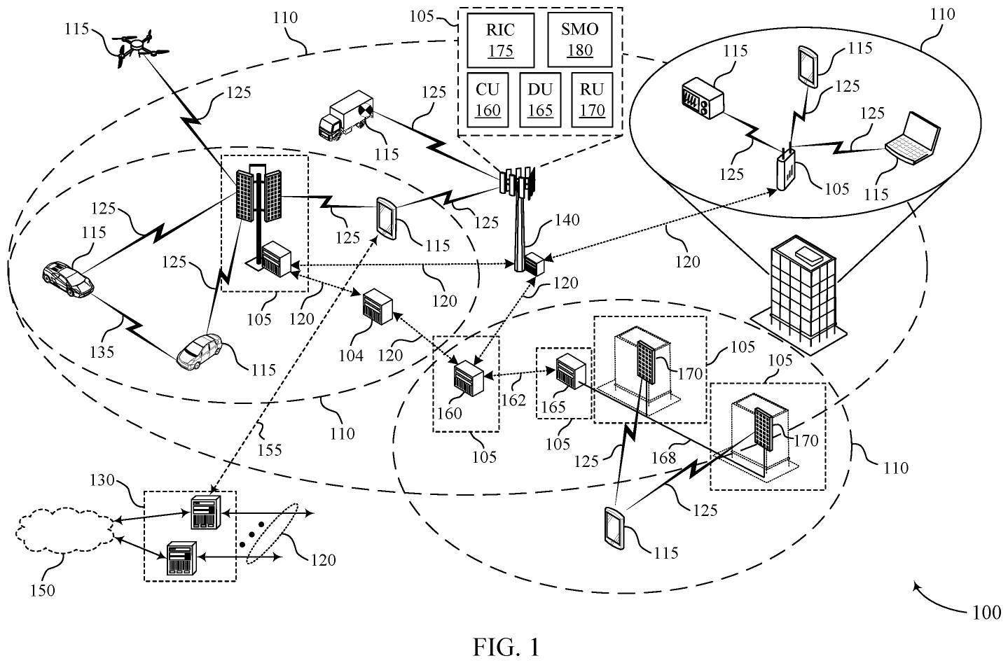

FIG. 1 illustrates an example of a wireless communications system 100 that supports transmission configuration indicators and precoding matrices for multiple transmissions in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support transmission configuration indicators and precoding matrices for multiple transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the UE 115 may receive a single control message (e.g., from a network entity 105) scheduling a transmission burst including multiple downlink messages. The single control message may indicate first and second groups of TCIs. The first group of TCIs may be associated with a first downlink shared channel and the second group of TCIs may be associated with a second downlink shared channel. The UE may monitor for a first downlink message in the first downlink shared channel using a first TCI and may further monitor for a second downlink message in the second downlink shared channel using a second TCI. For example, the UE 115 may switch from using the first TCI to the second TCI based on one or more factors, such as a timer, a quantity of negative acknowledgement messages, one or more other factors, or any combination thereof.

In some examples involving uplink transmissions, the UE may receive a single control message scheduling a transmission burst of uplink messages. The single control message may indicate to apply a first precoding matrix for transmission of the uplink messages. The UE may precode, using a second precoding matrix, an uplink message to generate a precoded first uplink message. The UE may transmit the precoded uplink message in a first uplink shared channel. In this way, the UE 115 may switch from using the first precoding matrix to the second precoding matrix based on one or more factors, such as a timer, a quantity of negative acknowledgement messages, one or more other factors, or any combination thereof.

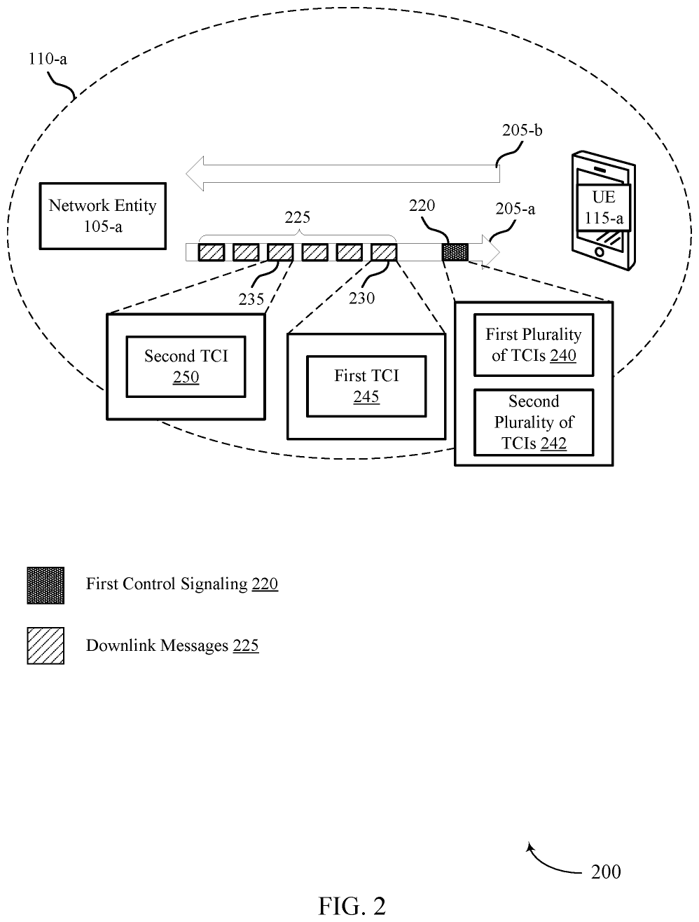

FIG. 2 illustrates an example of a wireless communications system 200 that supports transmission configuration indicators and precoding matrices for multiple transmissions in accordance with one or more examples as disclosed herein. The wireless communications system 200 may include the network entity 105-a, which may be an example of one or more network entities discussed in relation to other figures. The wireless communications system 200 may include the UE 115-a, which may be an example of UEs discussed in relation to other figures.

In some examples, the UE 115 a may be located in a geographic coverage area 110-a that may be associated with the network entity 105-a. The network entity 105-a and UE 115-a may communicate via one or more downlink communication links 205-a and one or more uplink communication links 205-b.

Some wireless communications may involve bursts of transmissions or packets. For example, some extended reality (XR) traffic (e.g., uplink, downlink, or sidelink XR traffic) may be video traffic that may involve such bursts of transmissions or packets. In some examples, such a “burst” may be a set of transmissions or packets that may be generated by an application within a period of time (e.g., a threshold period of time). For example, the downlink messages 225 or the uplink messages 425 may be collectively considered to be a “burst” of transmissions or packets. In some examples, for burst transmission, the network entity 105-a may (e.g., at the PHY layer) may transmit control signaling including a grant for the UE 115-a to communicate such a burst of packets or transmissions (e.g., uplink transmissions, downlink transmissions, or both). The control signaling may be a single instance of control signaling, such as a single DCI message (e.g., the first control signaling 220).

Additionally, or alternatively, some wireless communications may involve the use of TCIs. Such TCIs may indicate one or more parameters that are to be used for communication. The network entity 105-a may indicate via control signaling (e.g., MAC-CE control signaling) one or more TCIs that may be configured in other control signaling (e.g., RRC control signaling) for communications. In some examples, yet further control signaling (e.g., the first control signaling 220, which many be DCI signaling) may be used in conjunction with the one or more TCIs. For example, such DCI control signaling may indicate one or more TCIs (e.g., the first plurality of TCIs 240, the second plurality of TCIs 242, or any combination thereof) to be used for transmissions. For example, the DCI may include a multiple-bit field (e.g., a three bit field) to select or indicate a TCI state from the one or more configured TCIs. In some examples, if a scheduling gap between a control channel transmission and a shared channel transmission is more than a threshold quantity of symbols, a UE may use the TCI indicated in the DC. Otherwise, the UE may use a TCI associated with control signaling (e.g., MAC-CE signaling, RRC signaling, DCI signaling, or any combination thereof) for communications.

However, in some approaches, a single instance of control signaling used to schedule multiple transmissions (e.g., in a burst) may not account for adaptive configurations among the multiple transmissions. For example, different transmissions in a burst may be subject to different conditions which may lead to decreased communications quality if common parameters (e.g., TCI or precoding parameters) are used for all transmissions of the burst. In some such approaches, time domain resource allocations for the burst transmissions may be different, but other parameters may be uniform for different transmissions of the burst.

For example, TCI fields may be common among the multiple transmissions of the burst. Using such a common TCI field may be problematic because it may not be optimal for the multiple transmissions of the burst (scheduled by a single DCI) to use common TCI field, at least because conditions may not be uniform across the different transmissions of the burst. Such effects may decrease reliability and communications quality. Further, due to the scheduling gap that may be present between a control channel transmission and a shared channel transmission may cause the transmissions of the burst to use the single TCI used in the DCI.

For example, if a first downlink transmission is associated with a first TCI state (e.g., quasi co-located with a first reference signal) or a second TCI state (e.g., quasi co-located with a second reference signal). Further, a UE may receive the first reference signal in an interference environment (e.g., due to other transmissions from another cell in a burst interference environment, for instance) and the UE receives the second reference signal with reduced or no interference as compared to the interference environment. As such, if an environment of a subsequent communication includes interference, a filter, other communications parameters, or a communications configuration used to receive the first reference signal may be better suited to receive the subsequent communication. Alternatively, if the environment of the subsequent communication does not include interference, then a filter, other communications parameters, or a communications configuration used to receive the second reference signal may be better suited to receive the subsequent communication. Either way, reduced communications quality and reliability may result. As such, the techniques and subject matter described herein may improve or resolve such issues and offer increased reliability and communications quality for both downlink bursts and uplink bursts.

In some examples, the network entity 105-a may transmit the first control signaling 220 to the UE 115-a. The first control signaling 220 may schedule the downlink messages 225 (e.g., which may be a burst of transmissions or packets) and may further indicate the first plurality of TCIs 240 and the second plurality of TCIs 242. The first plurality of TCIs 240 may be associated with a first downlink channel and the second plurality of TCIs 242 may be associated with a second downlink channel. The UE 115-a may monitor the first downlink channel for the first downlink message 230 using the first TCI 245, may monitor the second downlink channel for the second downlink message 235 using the second TCI 250, or both. In some examples, the first TCI 245 may be selected from the first plurality of TCIs 240 and the second TCI 250 may be selected from the second plurality of TCIs 242.

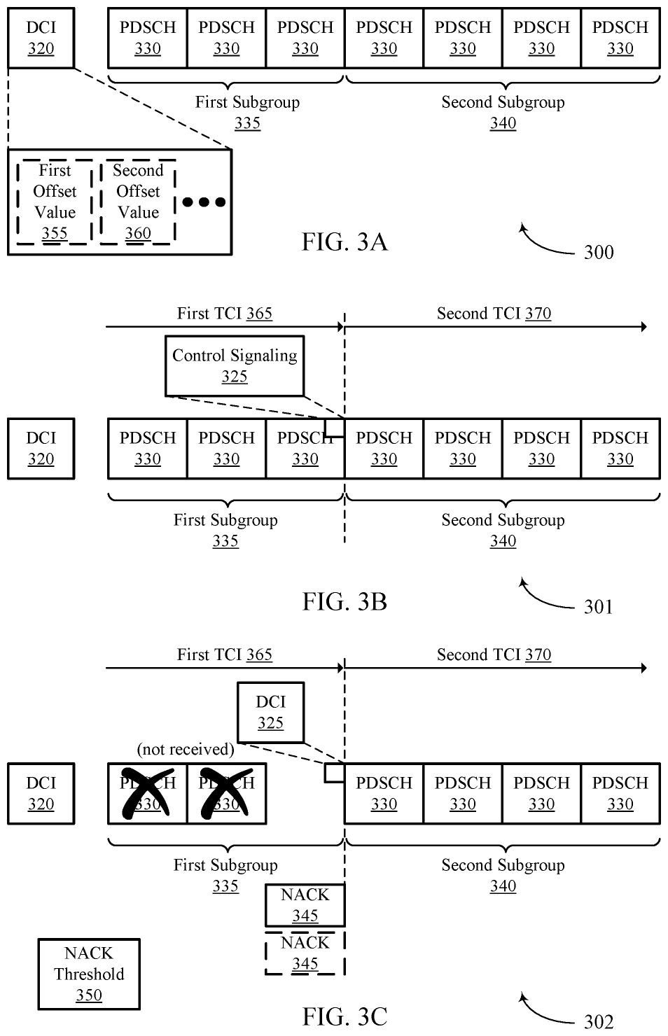

FIG. 3A illustrates an example of a downlink transmission scheme 300 that supports transmission configuration indicators and precoding matrices for multiple transmissions in accordance with one or more examples as disclosed herein.

In some examples, the DCI 320 may indicate multiple TCIs or TCI states for a PDSCH 330 or for multiple PDSCHs 330. For example, the DCI 320 may indicate a TCI for one or more PDSCHs 330 or for each PDSCH 330. Additionally, or alternatively, the DCI 320 may indicate a TCI for one or more subgroups of PDSCHs 330, such as the first subgroup 335, the second subgroup 340, or both.

Accordingly, the UE may use any of the TCIs for one or more of the PDSCHs 330. For example, the UE may use an indicated TCI based on one or more channel quality metrics, such as observed interference, a reference signal strength indicator (RSSI), a reference signal received power (RSRP), a reference signal received quality (RSRQ), a signal to interference and noise ratio (SINR), or any combination thereof. For example, the UE may use a first TCI for communicating the first subgroup 335 of PDSCHs 330 and may use a second TCI for communicating the second subgroup 340 of PDSCHs 330. Such a channel quality matric may be measured over a control channel (e.g., a PDCCH) or may be measured across one or more shared channel transmissions (e.g., PDSCH transmissions). As such, the UE may select which TCI from multiple available TCIs (e.g., the first plurality of TCIs 240, the second plurality of TCIs 242, or both) for the first subgroup 335, the second subgroup 340, or both based on one or more channel quality metrics. In some examples, one or more thresholds of one or more channel quality metrics may be used. For example, if a channel quality metric satisfies (e.g., is greater than, greater than or equal to, less than, or less than or equal to) such a threshold, a first TCI may be used. However, if the channel quality metric does not satisfy such a threshold, a second TCI may be used.

In some examples, a quantity of TCI states may be associated with a quantity of the PDSCHs 330. For example, the first offset value 355 and the second offset value 360, (and optionally one or more additional offset values) may be associated with a quantity of the PDSCHs 330. As, in some examples each subgroup (e.g., the first subgroup 335, the second subgroup 340, or both) may be associated with a same TCI state, as each subgroup may be associated with an uplink control channel or uplink control channel transmission, a HARQ codebook, or both. Therefore, a quantity of TCIs indicated in the DCI 320 may be equal to a quantity of offset values in the DCI 320 (e.g., a K1 offset), where such an offset value may describe an offset between the DCI 320 and one or more PDSCHs 330. For example, the first offset value 355 may be associated with a TCI state for the first subgroup 335 and the second offset value 360 may be associated with a TCI state for the second subgroup 340. Thus, the UE may infer or determine that, given two offset values in the DCI 320, that the UE is to use two TCI states for communicating the PDSCHs 330 (e.g., in the first subgroup 335 and the second subgroup 340.

In some examples the first offset value 355 may be associated with the first subgroup 335 and may be received via control signaling (e.g., RRC signaling or MAC-CE signaling). In such a case, the DCI 320 (or other DCI signaling) may indicate one or more TCIs for the first subgroup 335, the second subgroup 340, one or more additional subgroups, or any combination thereof. Additionally, or alternatively, the one or more TCIs may be indicated in the control signaling (e.g., the RRC signaling or the MAC-CE control signaling) and the DCI 320 may indicate a single TCI that may be associated with the first subgroup 335. Additionally, or alternatively, the DCI 320 may indicate multiple TCIs associated with multiple subgroups (the first subgroup 335, the second subgroup 340, one or more additional subgroups, or any combination thereof).

FIG. 3B illustrates an example of a downlink transmission scheme 301 that supports transmission configuration indicators and precoding matrices for multiple transmissions in accordance with one or more examples as disclosed herein.

In some examples, a network entity may transmit the control signaling 325 (e.g., MAC-CE signaling, RRC signaling, DCI signaling, or other control signaling) that may indicate that the UE is to use a different TCI for following communications. For example, the UE may use a first TCI 365 indicated in the DCI 320 to receive the first subgroup 335 of PDSCHs 330. The UE may receive the control signaling 325 that may indicate that the UE is to use the second TCI 370 indicated in the DCI 320 to receive the second subgroup 340 of PDSCHs 330. In some examples, the control signaling 325 may be received before the DCI 320 or before multiple such DCIs 320 scheduling multiple sets of PDSCH 330 bursts. In such cases, the control signaling 325 may indicate that the UE is to use a TCI indicated in the control signaling 325 for the PDSCHs 330 scheduled by the one or more DCIs 320.

FIG. 3C illustrates an example of a downlink transmission scheme 302 that supports transmission configuration indicators and precoding matrices for multiple transmissions in accordance with one or more examples as disclosed herein.

In some examples, the UE is not expected to use a different TCI for different PDSCHs 330 unless the UE transmits (e.g., and a network entity receives) a negative acknowledgement (NACK), such as NACK 345. For example, one or more PDSCHs 330 that were communicated using the first TCI 365 may not be received by the UE (e.g., due to channel conditions, interference, or one or more other factors). As such, the UE may transmit a NACK 345 to the network entity to indicate that the PDSCHs 330 (e.g., the PDSCHs 330 of the first subgroup 335) were not received. In such a scenario, the UE may use a second TCI 370 for communicating the PDSCHs 330 of the second subgroup 340 based on the NACK 345 (e.g., based on transmitted the NACK 345 or based on not receiving the PDSCHs 330 of the first subgroup 335). In some examples, despite having not received the PDSCHs 330 of the first subgroup 335 and transmitting the NACK 345, the UE may not use the second TCI 370 to communicate the PDSCHs 330 of the second subgroup 340 unless the UE has received the control signaling 325. The control signaling 325 may be a second-stage DCI and may indicate a change in TCI (e.g., from the first TCI 365 to the second TCI 370). The network entity may transmit the control signaling 325 to the UE based on receiving the NACK 345.

In some examples, feedback (e.g., HARQ-ACK feedback, a positive acknowledgement (ACK), a NACK, or any combination thereof) for the multiple PDSCHs 330 may be transmitted for different subgroups of the PDSCHs 330 (e.g., the first subgroup 335, the second subgroup 340, or both). Such feedback may be transmitted in uplink control channel resources across different time resources. For example, feedback for the first subgroup 335 may be transmitted in first time resources and feedback for the second subgroup 340 may be transmitted in second time resources.

In some examples, a change in a TCI that the UE is to use for

communicating the PDSCHs 330 (e.g., from the first TCI 365 to the second TCI 370) may be performed based on an error event or multiple NACKs 345. For example, the UE may be provided with multiple TCI states to be used for the first subgroup 335 and the second subgroup 340. If a quantity of NACKs 345 satisfies (e.g., is greater than or equal to) a NACK threshold 350, the TCI may be changed (e.g., the UE may use the second TCI 370 for communicating the PDSCHs 330 of the second subgroup 340 instead of the first TCI 365). Such TCI changes may occur at time boundaries between subgroups or may occur within a time in which PDSCHs of a subgroup are to be communicated.

In some examples, despite having not received the PDSCHs 330 of the first subgroup 335 and transmitting the NACKs 345, the UE may not use the second TCI 370 to communicate the PDSCHs 330 of the second subgroup 340 unless the UE has received the control signaling 325. The control signaling 325 may be a second-stage DCI and may indicate a change in TCI (e.g., from the first TCI 365 to the second TCI 370). The network entity may transmit the control signaling 325 to the UE based on receiving the NACK 345.

In some examples, similar techniques (as well as other techniques described throughout) may be used to determine or select changes in other communication parameters, such as a modulation and coding scheme (MCS), a transport block size (TBS), a rank, one or more other parameter, or any combination thereof.

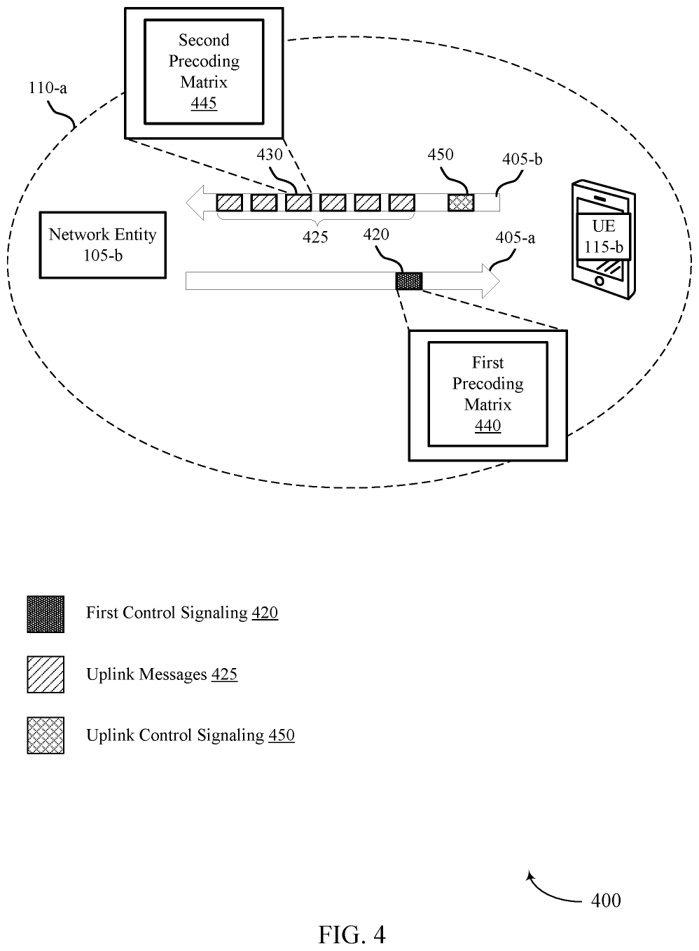

FIG. 4 illustrates an example of a wireless communications system 400 that supports transmission configuration indicators and precoding matrices for multiple transmissions in accordance with one or more examples as disclosed herein.

The wireless communications system 400 may include the network entity 105-a, which may be an example of one or more network entities discussed in relation to other figures. The wireless communications system 400 may include the UE 115-b, which may be an example of UEs discussed in relation to other figures.

In some examples, the UE 115-a may be located in a geographic coverage area 110-a that may be associated with the network entity 105-a. The network entity 105-a and UE 115-a may communicate via one or more downlink communication links 405-a and one or more uplink communication links 405-b.

In some examples, issues involving uplink communications (e.g., in which multiple uplink messages 425 are communicated in a burst scheduled by the first control signaling 420) may be similar to those issues described in relation to downlink communications described herein. For example, in other approaches, a single DCI that may schedule multiple uplink transmissions may not allow for adaptation of one or more communication parameters in an uplink grant (e.g., precoding parameters, a transmit precoding matrix indicator (TPMI), a rank indicator (RI), a sounding reference signal (SRS) resource indication (SRI), one or more other communication parameters, or any combination thereof) to be used for different uplink messages.

In some examples, the UE 115-b may receive the first control signaling 420 that may indicate the first precoding matrix 440 and the first control signaling 420 may further schedule the uplink messages 425 (e.g., that may form a burst of transmissions or packets). The UE 115-b may, however, use a second precoding matrix 445 to precode and transmit the first uplink message 430 (which may be a first-in-time uplink message). The second precoding matrix 445 may be a different precoding matrix than the first precoding matrix 440.

In some examples, the UE 115-b may indicate (e.g., to the network entity 105-b) that the UE 115-b will use the second precoding matrix 445 to transmit the first uplink message 430, one or more other uplink messages 425, or both. The UE 115-b may do so by transmitting a corresponding indication in the uplink control signaling 450 or in other signaling. In some examples, such control signaling indicating the change to the second precoding matrix 445 may be multiplexed on an uplink message 425 (e.g., a PUSCH message) or may be transmitted over dedicated control signaling resources (e.g., PUCCH resources).

In some examples, however, the UE 115-b may not transmit the uplink control signaling 450. Thus, to enable the network entity or receiver to perform blind detection is such cases, the UE 115-b may maintain or be provided with a set of precoding matrices (e.g., that may include the first precoding matrix 440, the second precoding matrix 445, or both) that the UE 115-b is permitted to use and switch between autonomously (e.g., without explicit or implicit indication of such a switch from the network entity 105-b). In some examples, the network entity or other receiver may transmit control signaling to configure the UE 115-d with the set of precoding matrices, and the UE 115-b may not be permitted to use other precoding matrices outside of the set of precoding matrices. Both the network entity 105-b and the UE 115-b may be aware of the set of precoding matrices. As such, even if the UE 115-b begins using the second precoding matrix 445 without indication from the network entity 105-b or without indicating such a change to the network entity 105-b, communication (e.g., with increased reliability and quality as described here) may still be possible.

In some examples, precoding information, a quantity of layers, a quantity of bits for precoding, or any combination thereof, may be determined by the UE 115-b based on one or more factors. For example, the UE 115-b may indicate that it will use the second precoding matrix 445 (e.g., in the uplink control signaling 450). The UE 115-b may then autonomously select or use a TCI based on observed interference or channel quality (e.g., through the use of one or more channel quality metrics, including observed interference, an RSSI, an RSRP, an RSRQ, an SINR, or any combination thereof). Such use of an interference or channel quality metric may involve an assumption that interference or channel conditions are symmetric between the UE 115-b and the network entity 105-b. For example, it may be assumed that an impact of interference or channel quality may be measured by the UE 115-b or that one or more interference or quality patterns may be observed. Additionally, or alternatively, it may be assumed that the UE 115-b may be communicating in sidelink communications with a wireless device and the techniques discussed herein may be used in the sidelink communications. In some examples, the UE 115-b may indicate to use one of a set of two or more TPMIs, RIs, SRIs (e.g., the network entity configures UE 115-b with the set), then the UE 115-b can autonomously use a TCI state based on observed interference (e.g., assuming symmetric interference at the UE 115-b and the receiver) or assuming that the impact of interference can be measured at the UE 115-b (e.g., at least patterns may be observed), or based on engagement in sidelink communication by the UE 115-b.

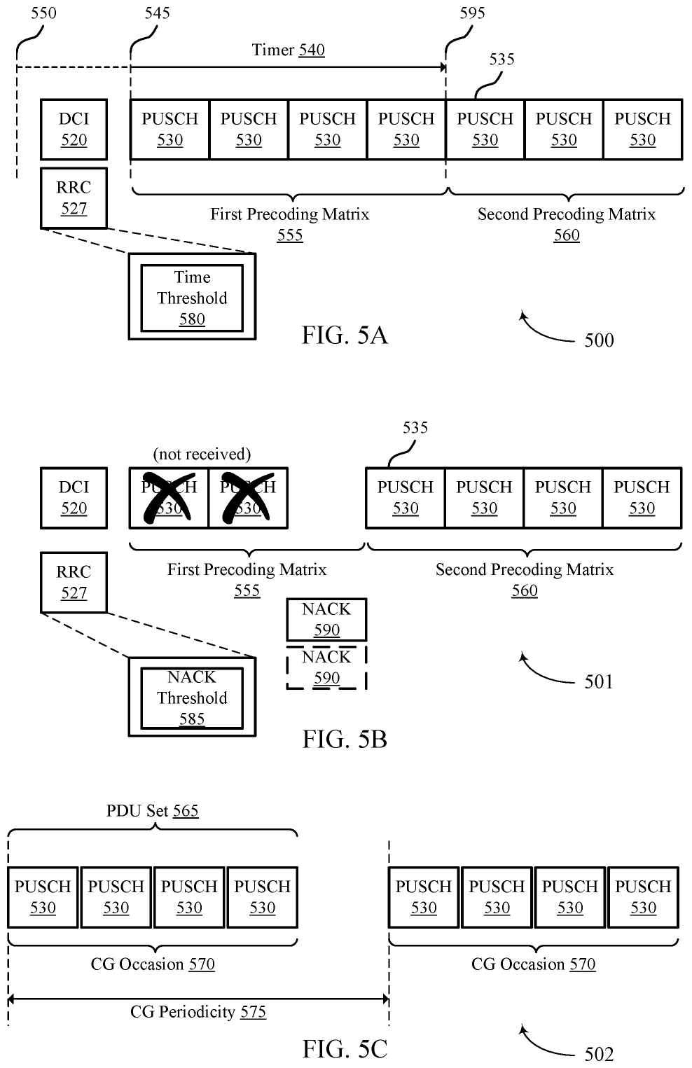

FIG. 5A illustrates an example of an uplink transmission scheme 500 that supports transmission configuration indicators and precoding matrices for multiple transmissions in accordance with one or more examples as disclosed herein.

In some examples, precoding information, a quantity of layers, a quantity of bits for precoding, or any combination thereof, may be determined by the UE 115-b based on one or more factors. For example, the UE may use the first precoding matrix 555 for transmitting a quantity of PUSCHs 530 and may switch to using the second precoding matrix 560 for transmitting another quantity of PUSCHs 530 (e.g., including the first PUSCH 535) based on a timer 540. For example, in response to or based on expiration of the timer 540, the UE may use the second precoding matrix 560 to transmit one or more PUSCHs 530 (e.g., including the first PUSCH 535). For example, the UE may change digital beamforming, analog beamforming, or both (e.g., one or more TPMIs, SRIs, or both) that were indicated by the network entity in the DCI 520 based on a time threshold being exceeded or an expiration of the timer 540 (either or both of which may occur, as examples, at point 595).

The timer 540 may measure an amount of time passing since a beginning slot of a first PUSCH 530 (e.g., at point 545) of the set of PUSCHs 530 scheduled by the DCI 520 or a quantity of PUSCHs 530 configured on a same configured grant (CG) occasion. Additionally, or alternatively, the timer 540 may measure an amount of time passing since a start of beginning of connected mode discontinuous reception (CDRX) operation (e.g., at point 550). In some examples, the timer 540 may expire once a measured amount of time satisfies (e.g., is greater than or equal to) a time threshold 580. In some examples, such a time threshold 580 may be indicated in control signaling, such as the DCI 520, the RRC signaling 527, or other control signaling (e.g., MAC-CE signaling, RRC signaling, DCI signaling, other control signaling, or any combination thereof).

In some examples, the amount of time measured by the timer 540 may be compared to a delay budget. If the amount of time measured by the timer 540 satisfies the delay budget (e.g., is less than, less than or equal to, greater than, or greater than or equal to), the UE may use the second precoding matrix 560 for transmitting a quantity of PUSCHs 530. For example, if a time measured by the timer 540 exceeds a timer threshold or a delay budget and the first precoding matrix 555, a first TPMI, or both was indicated to the UE for use by the UE (e.g., in control signaling from the network entity such as the DCI 520 or the RRC signaling 527), the UE may be permitted to switch to the second precoding matrix 560, a second TPMI, or both. In some examples, a delay budget for the burst of PUSCHs 530 may be received from the network entity or other wireless device, optionally as part of a quality of service negotiation process or procedure.

FIG. 5B illustrates an example of an uplink transmission scheme 501 that supports transmission configuration indicators and precoding matrices for multiple transmissions in accordance with one or more examples as disclosed herein.

In some examples, the UE may use the first precoding matrix 555 for transmitting a quantity of PUSCHs 530 and may switch to using the second precoding matrix 560 for transmitting another quantity of PUSCHs 530 (e.g., including the first PUSCH 535) based on receiving a defined quantity of one or more NACKs 590. For example, the UE may change digital beamforming, analog beamforming, or both (e.g., one or more TPMIs, SRIs, or both) that were indicated by the network entity in the DCI 520 based on receiving the one or more NACKs 590 that may be transmitted to the UE by a network entity or other device that did not receive one or more of the PUSCHs 530. Based on the one or more NACKs 590, the UE may switch from the first precoding matrix 555 to the second precoding matrix 560 for precoding and transmission of one or more PUSCHs 530 (e.g., including the first PUSCH 535). In some examples, receiving a single NACK 590 may trigger the change, whereas in other examples, multiple NACKs 590 may be received before switching to the second precoding matrix 560. For example, the UE may receive RRC signaling 527 (or other control signaling) that may indicate the NACK threshold 585. If a quantity of NACKs 590 satisfies (e.g., is greater than or equal to) the NACK threshold 585, then the UE may use the second precoding matrix 560 for transmitting a quantity of PUSCHs 530 (e.g., including the first PUSCH 535). In some examples, the network entity or other device sending DCI feedback indicating ACK or NACK from gNB may also indicate in the feedback an instruction for the UE 115-b to change TPMI, SRI, or both (e.g., analog and/or digital beamforming used by the UE 115-b).

In some examples, despite the network entity not having received the PUSCHs 530 and transmitting the NACKs 590 to the UE, the UE may not use the second precoding matrix 560 for transmitting another quantity of PUSCHs 530 unless the UE has received an indication in one or more of the NACKs 590 that the UE is to use the second precoding matrix 560. For example, in some cases, the network entity may transmit an indicating along with or in a NACK 590 that the UE is to use the second precoding matrix 560 for transmitting a quantity of PUSCHs 530, and the UE may do so based on receiving such an indicating in a NACK 590.

FIG. 5C illustrates an example of an uplink transmission scheme 502 that supports transmission configuration indicators and precoding matrices for multiple transmissions in accordance with one or more examples as disclosed herein.

In some examples, the techniques described herein (e.g., those for uplink communications, downlink communications, or both) may be applied to a single semi-persistent scheduling (SPS) or configured grant (CG) occasion that may be associated with multiple PUSCHs 530. For example, the multiple PUSCHs 530 may be associated with a physical data unit (PDU) set 565 in the CG occasion 570, and CG occasions 570 may occur with a CG periodicity 575. In some examples, the SPS or CG occasion 570 may be activated by a single DCI (e.g., the DCI 520 or other DCI described herein that may schedule multiple transmissions or packets in a burst). Though the example depicted here describes PUSCHs 530 (and may also be applicable to other uplink transmissions, such as the uplink messages 425), the techniques described here are equally applicable to downlink transmissions, such as the PDSCHs 330, the downlink messages 225, or both, as described herein.

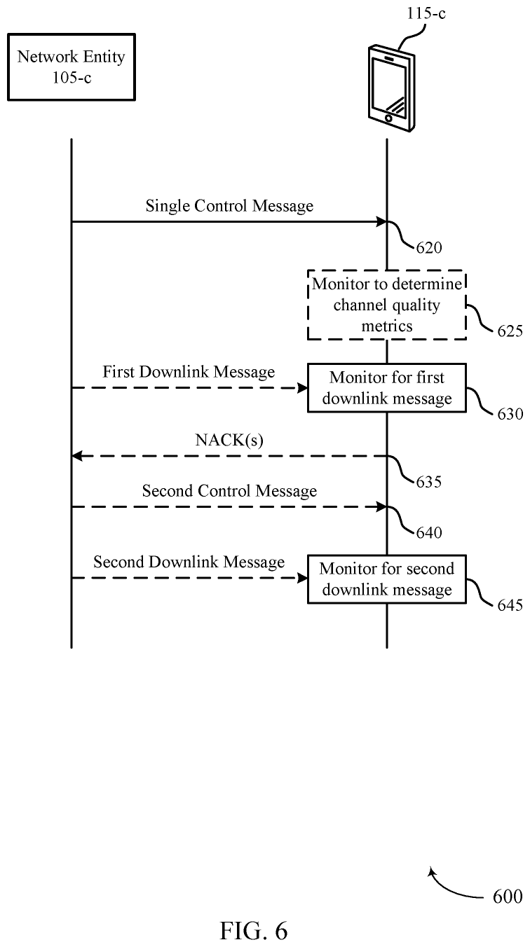

FIG. 6 illustrates an example of a process flow 600 that supports transmission configuration indicators and precoding matrices for multiple transmissions in accordance with one or more examples as disclosed herein. The process flow 600 may implement various aspects of the present disclosure described herein. The elements described in the process flow 600 (e.g., the UE 115-c and the network entity 105-c) may be examples of similarly-named elements described herein.

In the following description of the process flow 600, the operations between the various entities or elements may be performed in different orders or at different times. Some operations may also be left out of the process flow 600, or other operations may be added. Although the various entities or elements are shown performing the operations of the process flow 600, some aspects of some operations may also be performed by other entities or elements of the process flow 600 or by entities or elements that are not depicted in the process flow, or any combination thereof.

At 620, the UE 115-c may receive a single control message scheduling a transmission burst that may include a plurality of downlink messages communicated in a plurality of downlink shared channels, the single control message that may indicate a first plurality of transmission configuration indicators associated with a first downlink shared channel of the plurality of downlink shared channels and a second plurality of transmission configuration indicators associated with a second downlink shared channel of the plurality of downlink shared channels. In some examples, the UE 115-c may receive the single control message that may indicate a first feedback offset value and a second feedback offset value,

At 625, the UE 115-c may monitor the first downlink shared channel or a first control channel associated with the first downlink shared channel to determine a first channel quality metric. Additionally, or alternatively, the UE 115-c may monitor the second downlink shared channel or a second control channel associated with the second downlink shared channel to determine a second channel quality metric.

At 630, the UE 115-c may monitor for a first downlink message of the plurality of downlink messages in the first downlink shared channel using a first transmission configuration indicator selected from the first plurality of transmission configuration indicators. In some examples, the first transmission configuration indicator is selected for the first downlink shared channel based on the first channel quality metric. In some examples, the first downlink shared channel is monitored using the first transmission configuration indicator based on the first feedback offset value.

At 635, the UE 115-c may transmit one or more negative acknowledgement messages associated with failure to receive the first downlink message via the first downlink shared channel.

At 640, the UE 115-c may receive a second control message that may indicate that the UE is to use the second transmission configuration indicator to monitor for the second downlink message. Additionally, or alternatively, the UE 115-c may receive, based on the transmission of the one or more negative acknowledgement messages, the second control message that may indicate that the UE is to monitor for the second downlink message in the second downlink shared channel using the second transmission configuration indicator.

At 645, the UE 115-c may monitor for a second downlink message of the plurality of downlink messages in the second downlink shared channel using a second transmission configuration indicator selected from the second plurality of transmission configuration indicators. In some examples, the second transmission configuration indicator may be selected for the second downlink shared channel based on the second channel quality metric. In some examples, the second downlink shared channel is monitored using the second transmission configuration indicator based on the second control message. In some examples, the UE 115-c may monitor for the second downlink message in the second downlink shared channel using the second transmission configuration indicator based on a quantity of the one or more negative acknowledgement messages being greater than or equal to a negative acknowledgement message quantity threshold. In some examples, the UE 115-c may monitor the second downlink shared channel using the second transmission configuration indicator based on the second feedback offset value.

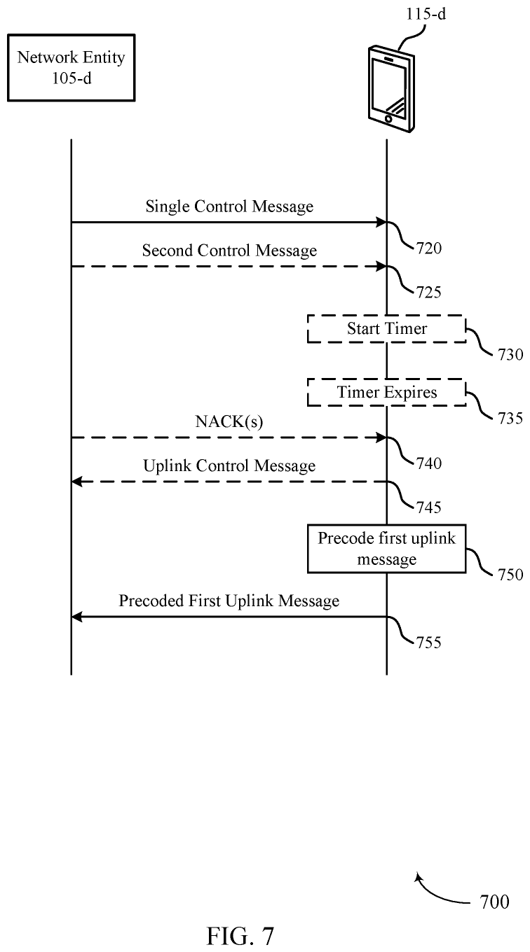

FIG. 7 illustrates an example of a process flow 700 that supports transmission configuration indicators and precoding matrices for multiple transmissions in accordance with one or more examples as disclosed herein. The process flow 700 may implement various aspects of the present disclosure described herein. The elements described in the process flow 700 (e.g., the UE 115-d and the network entity 105-d) may be examples of similarly-named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 720, the UE 115-d may receive a single control message scheduling a transmission burst that may include a plurality of uplink messages communicated in a plurality of uplink shared channels, and the single control message may indicate to apply a first precoding matrix for transmission of the plurality of uplink messages.

At 725, the UE 115-d may receive a second control message indicating a time threshold at which a timer is to expire. Additionally, or alternatively, the UE 115-d may receive a second control message indicating the negative acknowledgement message quantity threshold.

At 730, the UE 115-d may start the timer at a first time corresponding with a first slot of a first-in-time uplink message of the plurality of uplink messages or at a second time corresponding to a beginning of connected mode discontinuous reception operation of the UE.

At 735, the timer may expire.

At 740, the UE 115-d may receive a plurality of negative acknowledgement messages associated with one or more uplink messages of the plurality of uplink messages.

At 745, the UE 115-d may transmit an uplink control message indicating that the first uplink message is to be precoded using the second precoding matrix. In some examples, uplink control message is multiplexed with an uplink message of the plurality of uplink messages

At 750, the UE 115-d may precode, using a second precoding matrix that is different than the first precoding matrix, a first uplink message of the plurality of uplink messages to generate a precoded first uplink message. In some examples, the UE 115-d may precode the first uplink message using the second precoding matrix based on a quantity of the plurality of negative acknowledgement messages being greater than or equal to a negative acknowledgement message quantity threshold. In some examples, the second precoding matrix is selected from a plurality of precoding matrices permitted to be used by the UE.

At 755, the UE 115-d may transmit the precoded first uplink message in a first uplink shared channel of the plurality of uplink shared channels. In some examples, the UE 115-d may precode the first uplink message using the second precoding matrix based on the expiry of the timer relative to receipt of the single control message. In some examples, the UE 115-d may transmit the precoded first uplink message using a first transmission configuration indicator based on one or more indications of channel quality of the first uplink shared channel.

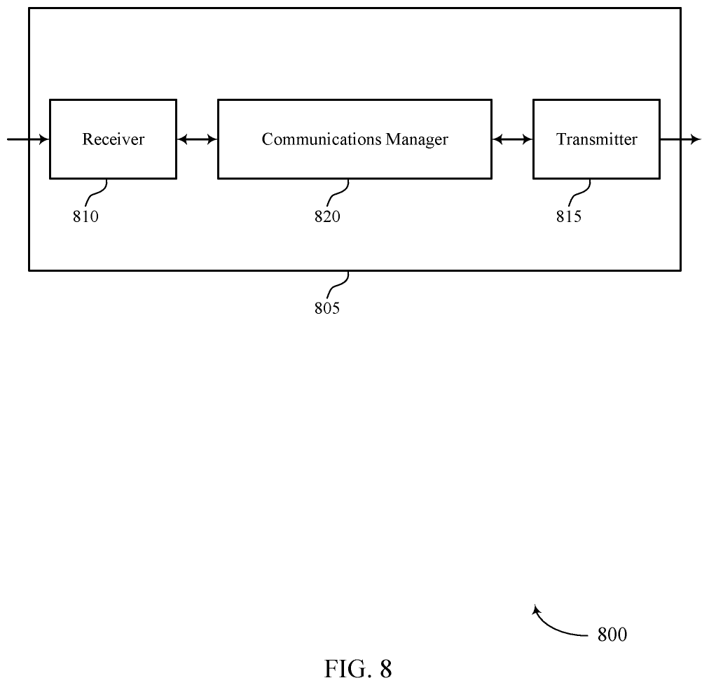

FIG. 8 illustrates a block diagram 800 of a device 805 that supports transmission configuration indicators and precoding matrices for multiple transmissions in accordance with one or more examples as disclosed herein. The device 805 may be an example of aspects of a UE 115 as described herein. The device 805 may include a receiver 810, a transmitter 815, and a communications manager 820. The device 805 may also include one or more processors, memory coupled with the one or more processors, and instructions stored in the memory that are executable by the one or more processors to enable the one or more processors to perform the multiple transmission features discussed herein. Each of these components may be in communication with one another (e.g., via one or more buses).

The receiver 810 may provide a means for receiving information such as packets, user data, control information, or any combination thereof associated with various information channels (e.g., control channels, data channels, information channels related to transmission configuration indicators and precoding matrices for multiple transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to transmission configuration indicators and precoding matrices for multiple transmissions). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of transmission configuration indicators and precoding matrices for multiple transmissions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications at a UE in accordance with examples as disclosed herein. For example, the communications manager 820 may be configured as or otherwise support a means for receiving a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels. The communications manager 820 may be configured as or otherwise support a means for monitoring for a first downlink message of the set of multiple downlink messages in the first downlink shared channel using a first transmission configuration indicator selected from the first set of multiple transmission configuration indicators. The communications manager 820 may be configured as or otherwise support a means for monitoring for a second downlink message of the set of multiple downlink messages in the second downlink shared channel using a second transmission configuration indicator selected from the second set of multiple transmission configuration indicators.

Additionally, or alternatively, the communications manager 820 may support wireless communications at a UE in accordance with examples as disclosed herein. For example, the communications manager 820 may be configured as or otherwise support a means for receiving a single control message scheduling a transmission burst including a set of multiple uplink messages communicated in a set of multiple uplink shared channels, the single control message indicating to apply a first precoding matrix for transmission of the set of multiple uplink messages. The communications manager 820 may be configured as or otherwise support a means for precoding, using a second precoding matrix that is different than the first precoding matrix, a first uplink message of the set of multiple uplink messages to generate a precoded first uplink message. The communications manager 820 may be configured as or otherwise support a means for transmitting the precoded first uplink message in a first uplink shared channel of the set of multiple uplink shared channels.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, more efficient utilization of communication resources, or any combination thereof.

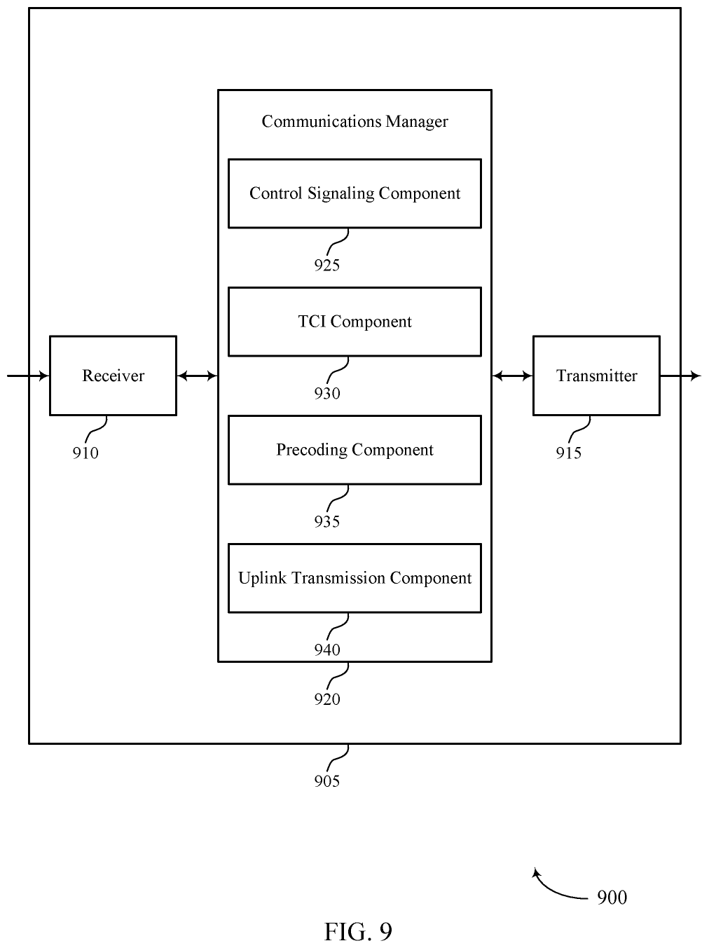

FIG. 9 illustrates a block diagram 900 of a device 905 that supports transmission configuration indicators and precoding matrices for multiple transmissions in accordance with one or more examples as disclosed herein. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to transmission configuration indicators and precoding matrices for multiple transmissions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to transmission configuration indicators and precoding matrices for multiple transmissions). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of transmission configuration indicators and precoding matrices for multiple transmissions as described herein. For example, the communications manager 920 may include a control signaling component 925, a TCI component 930, a precoding component 935, an uplink transmission component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The control signaling component 925 may be configured as or otherwise support a means for receiving a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels. The TCI component 930 may be configured as or otherwise support a means for monitoring for a first downlink message of the set of multiple downlink messages in the first downlink shared channel using a first transmission configuration indicator selected from the first set of multiple transmission configuration indicators. The TCI component 930 may be configured as or otherwise support a means for monitoring for a second downlink message of the set of multiple downlink messages in the second downlink shared channel using a second transmission configuration indicator selected from the second set of multiple transmission configuration indicators.

Additionally, or alternatively, the communications manager 920 may support wireless communications at a UE in accordance with examples as disclosed herein. The control signaling component 925 may be configured as or otherwise support a means for receiving a single control message scheduling a transmission burst including a set of multiple uplink messages communicated in a set of multiple uplink shared channels, the single control message indicating to apply a first precoding matrix for transmission of the set of multiple uplink messages. The precoding component 935 may be configured as or otherwise support a means for precoding, using a second precoding matrix that is different than the first precoding matrix, a first uplink message of the set of multiple uplink messages to generate a precoded first uplink message. The uplink transmission component 940 may be configured as or otherwise support a means for transmitting the precoded first uplink message in a first uplink shared channel of the set of multiple uplink shared channels.

In some cases, the control signaling component 925, the TCI component 930, the precoding component 935, and the uplink transmission component 940 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 925, the TCI component 930, the precoding component 935, and the uplink transmission component 940 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

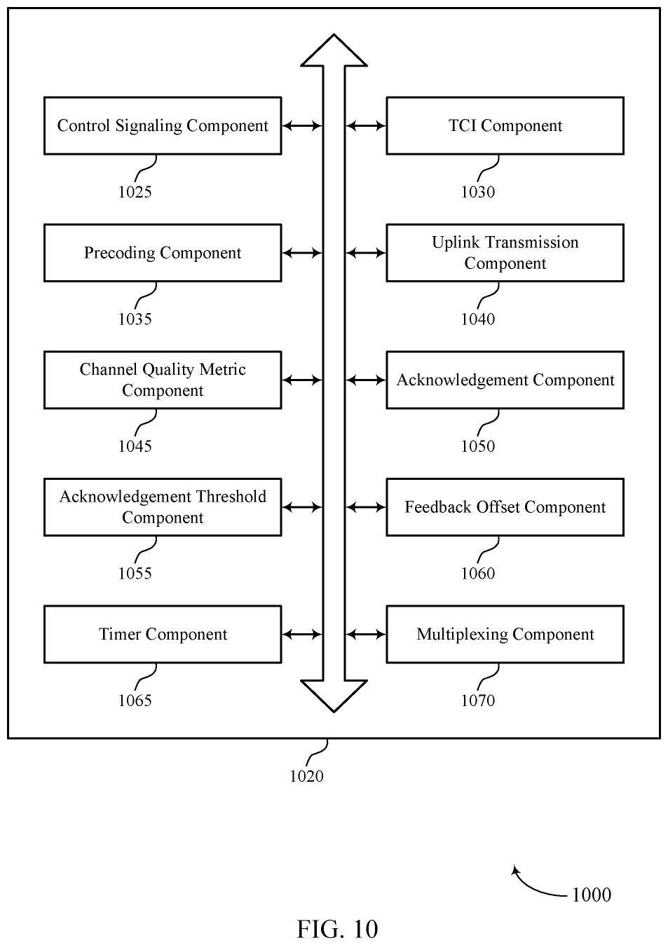

FIG. 10 illustrates a block diagram 1000 of a communications manager 1020 that supports transmission configuration indicators and precoding matrices for multiple transmissions in accordance with one or more examples as disclosed herein. The communications manager 1020 may be an example of aspects of a communications manager 820, a communications manager 920, or both, as described herein. The communications manager 1020, or various components thereof, may be an example of means for performing various aspects of transmission configuration indicators and precoding matrices for multiple transmissions as described herein. For example, the communications manager 1020 may include a control signaling component 1025, a TCI component 1030, a precoding component 1035, an uplink transmission component 1040, a channel quality metric component 1045, an acknowledgement component 1050, an acknowledgement threshold component 1055, a feedback offset component 1060, a timer component 1065, a multiplexing component 1070, or any combination thereof. Each of these components may communicate, directly or indirectly, with one another (e.g., via one or more buses).

Additionally, or alternatively, the communications manager 1020 may support wireless communications at a UE in accordance with examples as disclosed herein. The control signaling component 1025 may be configured as or otherwise support a means for receiving a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels. The TCI component 1030 may be configured as or otherwise support a means for monitoring for a first downlink message of the set of multiple downlink messages in the first downlink shared channel using a first transmission configuration indicator selected from the first set of multiple transmission configuration indicators. In some examples, the TCI component 1030 may be configured as or otherwise support a means for monitoring for a second downlink message of the set of multiple downlink messages in the second downlink shared channel using a second transmission configuration indicator selected from the second set of multiple transmission configuration indicators.

In some examples, the channel quality metric component 1045 may be configured as or otherwise support a means for monitoring the first downlink shared channel or a first control channel associated with the first downlink shared channel to determine a first channel quality metric. In some examples, the channel quality metric component 1045 may be configured as or otherwise support a means for monitoring the second downlink shared channel or a second control channel associated with the second downlink shared channel to determine a second channel quality metric. In some examples, the TCI component 1030 may be configured as or otherwise support a means for where the first transmission configuration indicator is selected for the first downlink shared channel based on the first channel quality metric, and where the second transmission configuration indicator is selected for the second downlink shared channel based on the second channel quality metric.

In some examples, the control signaling component 1025 may be configured as or otherwise support a means for receiving a second control message indicating that the UE is to use the second transmission configuration indicator to monitor for the second downlink message. In some examples, the TCI component 1030 may be configured as or otherwise support a means for where the second downlink shared channel is monitored using the second transmission configuration indicator based on the second control message.

In some examples, the acknowledgement component 1050 may be configured as or otherwise support a means for transmitting one or more negative acknowledgement messages associated with failure to receive the first downlink message via the first downlink shared channel. In some examples, the TCI component 1030 may be configured as or otherwise support a means for receiving, based on transmitting the one or more negative acknowledgement messages, a second control message indicating that the UE is to monitor for the second downlink message in the second downlink shared channel using the second transmission configuration indicator.

In some examples, the acknowledgement component 1050 may be configured as or otherwise support a means for transmitting one or more negative acknowledgement messages associated with failure to receive the first downlink message via the first downlink shared channel. In some examples, the acknowledgement threshold component 1055 may be configured as or otherwise support a means for monitoring for the second downlink message in the second downlink shared channel using the second transmission configuration indicator based on a quantity of the one or more negative acknowledgement messages being greater than or equal to a negative acknowledgement message quantity threshold.

In some examples, the feedback offset component 1060 may be configured as or otherwise support a means for receiving the single control message indicating a first feedback offset value and a second feedback offset value. In some examples, the TCI component 1030 may be configured as or otherwise support a means for where the first downlink shared channel is monitored using the first transmission configuration indicator based on the first feedback offset value, and where the second downlink shared channel is monitored using the second transmission configuration indicator based on the second feedback offset value.

Additionally, or alternatively, the communications manager 1020 may support wireless communications at a UE in accordance with examples as disclosed herein. In some examples, the control signaling component 1025 may be configured as or otherwise support a means for receiving a single control message scheduling a transmission burst including a set of multiple uplink messages communicated in a set of multiple uplink shared channels, the single control message indicating to apply a first precoding matrix for transmission of the set of multiple uplink messages. The precoding component 1035 may be configured as or otherwise support a means for precoding, using a second precoding matrix that is different than the first precoding matrix, a first uplink message of the set of multiple uplink messages to generate a precoded first uplink message. The uplink transmission component 1040 may be configured as or otherwise support a means for transmitting the precoded first uplink message in a first uplink shared channel of the set of multiple uplink shared channels.

In some examples, the precoding component 1035 may be configured as or otherwise support a means for precoding the first uplink message using the second precoding matrix based on an expiry of a timer relative to receipt of the single control message.

In some examples, the timer component 1065 may be configured as or otherwise support a means for receiving a second control message indicating a time threshold at which the timer is to expire.

In some examples, the timer component 1065 may be configured as or otherwise support a means for starting the timer at a first time corresponding with a first slot of a first-in-time uplink message of the set of multiple uplink messages or at a second time corresponding to a beginning of connected mode discontinuous reception operation of the UE.

In some examples, the acknowledgement component 1050 may be configured as or otherwise support a means for receiving a set of multiple negative acknowledgement messages associated with one or more uplink messages of the set of multiple uplink messages. In some examples, the precoding component 1035 may be configured as or otherwise support a means for precoding the first uplink message using the second precoding matrix based on a quantity of the set of multiple negative acknowledgement messages being greater than or equal to a negative acknowledgement message quantity threshold.

In some examples, the acknowledgement threshold component 1055 may be configured as or otherwise support a means for receiving a second control message indicating the negative acknowledgement message quantity threshold.

In some examples, the control signaling component 1025 may be configured as or otherwise support a means for transmitting an uplink control message indicating that the first uplink message is to be precoded using the second precoding matrix.

In some examples, the TCI component 1030 may be configured as or otherwise support a means for transmitting the precoded first uplink message using a first transmission configuration indicator based on one or more indications of channel quality of the first uplink shared channel.

In some examples, the uplink control message is multiplexed with an uplink message of the set of multiple uplink messages.

In some examples, the second precoding matrix is selected from a set of multiple precoding matrices permitted to be used by the UE.

In some cases, the control signaling component 1025, the TCI component 1030, the precoding component 1035, the uplink transmission component 1040, the channel quality metric component 1045, the acknowledgement component 1050, the acknowledgement threshold component 1055, the feedback offset component 1060, the timer component 1065, and the multiplexing component 1070 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 1025, the TCI component 1030, the precoding component 1035, the uplink transmission component 1040, the channel quality metric component 1045, the acknowledgement component 1050, the acknowledgement threshold component 1055, the feedback offset component 1060, the timer component 1065, and the multiplexing component 1070 discussed herein.

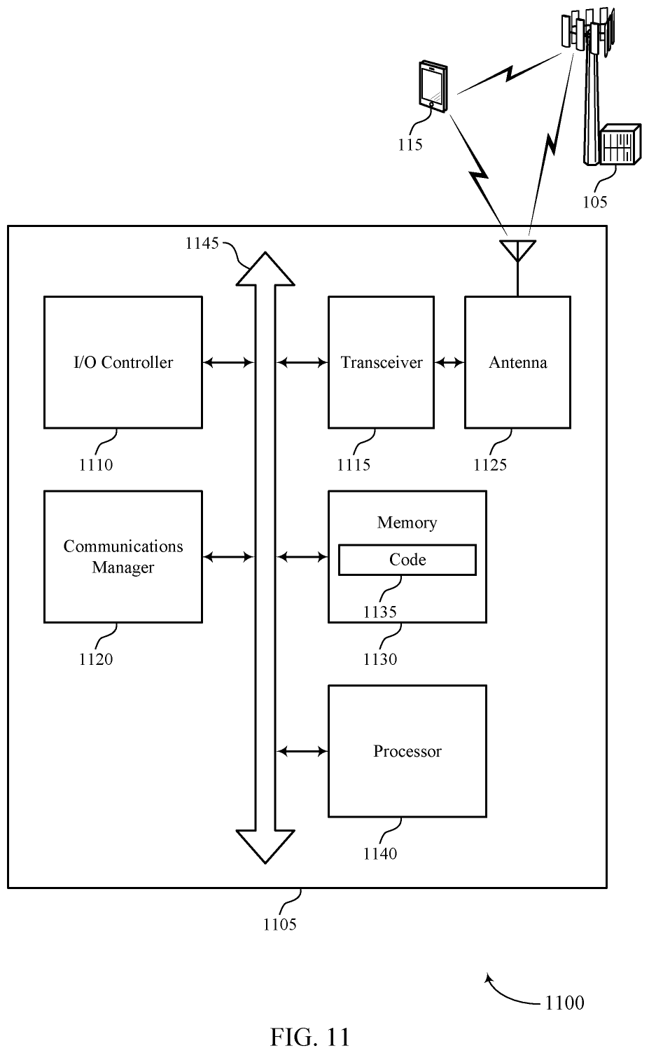

FIG. 11 illustrates a diagram of a system 1100 including a device 1105 that supports transmission configuration indicators and precoding matrices for multiple transmissions in accordance with one or more examples as disclosed herein. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting transmission configuration indicators and precoding matrices for multiple transmissions). For example, the device 1105 or a component of the device 1105 may include a processor 1140 and memory 1130 coupled with or to the processor 1140, the processor 1140 and memory 1130 configured to perform various functions described herein.

Additionally, or alternatively, the communications manager 1120 may support wireless communications at a UE in accordance with examples as disclosed herein. For example, the communications manager 1120 may be configured as or otherwise support a means for receiving a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels. The communications manager 1120 may be configured as or otherwise support a means for monitoring for a first downlink message of the set of multiple downlink messages in the first downlink shared channel using a first transmission configuration indicator selected from the first set of multiple transmission configuration indicators. The communications manager 1120 may be configured as or otherwise support a means for monitoring for a second downlink message of the set of multiple downlink messages in the second downlink shared channel using a second transmission configuration indicator selected from the second set of multiple transmission configuration indicators.

Additionally, or alternatively, the communications manager 1120 may support wireless communications at a UE in accordance with examples as disclosed herein. For example, the communications manager 1120 may be configured as or otherwise support a means for receiving a single control message scheduling a transmission burst including a set of multiple uplink messages communicated in a set of multiple uplink shared channels, the single control message indicating to apply a first precoding matrix for transmission of the set of multiple uplink messages. The communications manager 1120 may be configured as or otherwise support a means for precoding, using a second precoding matrix that is different than the first precoding matrix, a first uplink message of the set of multiple uplink messages to generate a precoded first uplink message. The communications manager 1120 may be configured as or otherwise support a means for transmitting the precoded first uplink message in a first uplink shared channel of the set of multiple uplink shared channels.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of transmission configuration indicators and precoding matrices for multiple transmissions as described herein, or the processor 1140 and the memory 1130 may be otherwise configured to perform or support such operations.

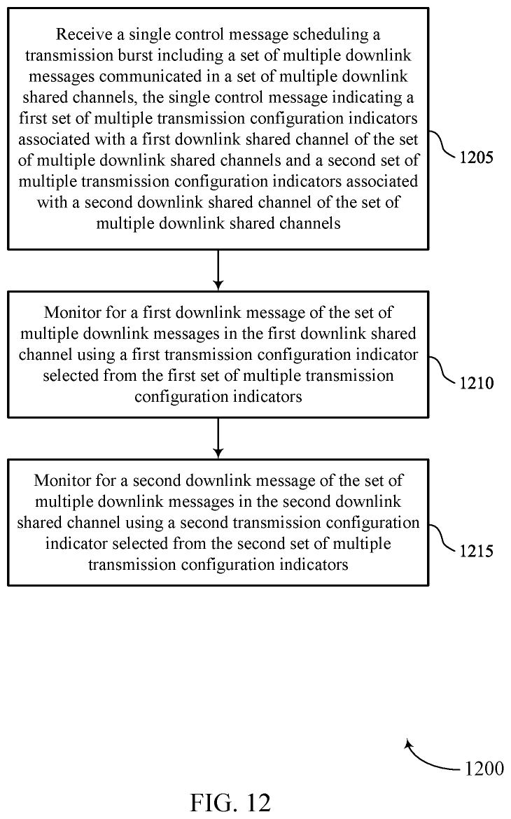

FIG. 12 illustrates a flowchart showing a method 1200 that supports transmission configuration indicators and precoding matrices for multiple transmissions in accordance with one or more examples as disclosed herein. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a single control message scheduling a transmission burst including a set of multiple downlink messages communicated in a set of multiple downlink shared channels, the single control message indicating a first set of multiple transmission configuration indicators associated with a first downlink shared channel of the set of multiple downlink shared channels and a second set of multiple transmission configuration indicators associated with a second downlink shared channel of the set of multiple downlink shared channels. The operations of 1205 may be performed in accordance with examples as disclosed herein. In some examples, aspects of the operations of 1205 may be performed by a control signaling component 1025 as described with reference to FIG. 10.

At 1210, the method may include monitoring for a first downlink message of the set of multiple downlink messages in the first downlink shared channel using a first transmission configuration indicator selected from the first set of multiple transmission configuration indicators. The operations of 1210 may be performed in accordance with examples as disclosed herein. In some examples, aspects of the operations of 1210 may be performed by a TCI component 1030 as described with reference to FIG. 10.

At 1215, the method may include monitoring for a second downlink message of the set of multiple downlink messages in the second downlink shared channel using a second transmission configuration indicator selected from the second set of multiple transmission configuration indicators. The operations of 1215 may be performed in accordance with examples as disclosed herein. In some examples, aspects of the operations of 1215 may be performed by a TCI component 1030 as described with reference to FIG. 10.

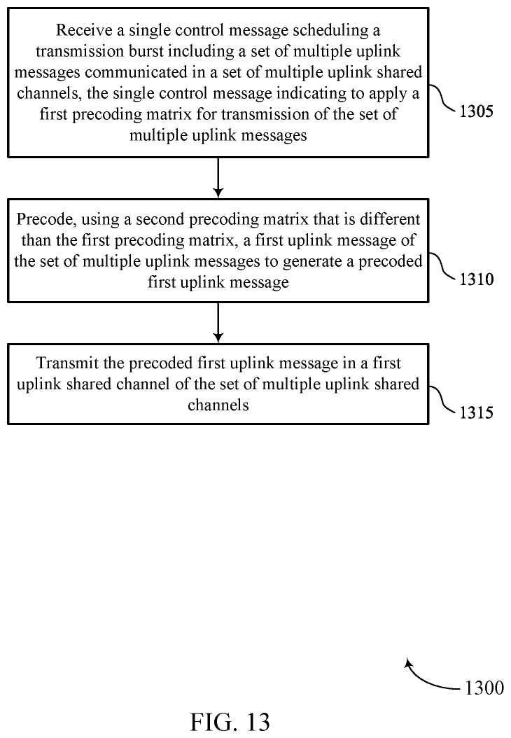

FIG. 13 illustrates a flowchart showing a method 1300 that supports transmission configuration indicators and precoding matrices for multiple transmissions in accordance with one or more examples as disclosed herein. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving a single control message scheduling a transmission burst including a set of multiple uplink messages communicated in a set of multiple uplink shared channels, the single control message indicating to apply a first precoding matrix for transmission of the set of multiple uplink messages. The operations of 1305 may be performed in accordance with examples as disclosed herein. In some examples, aspects of the operations of 1305 may be performed by a control signaling component 1025 as described with reference to FIG. 10.

At 1310, the method may include precoding, using a second precoding matrix that is different than the first precoding matrix, a first uplink message of the set of multiple uplink messages to generate a precoded first uplink message. The operations of 1310 may be performed in accordance with examples as disclosed herein. In some examples, aspects of the operations of 1310 may be performed by a precoding component 1035 as described with reference to FIG. 10.

At 1315, the method may include transmitting the precoded first uplink message in a first uplink shared channel of the set of multiple uplink shared channels. The operations of 1315 may be performed in accordance with examples as disclosed herein. In some examples, aspects of the operations of 1315 may be performed by an uplink transmission component 1040 as described with reference to FIG. 10.

The following provides an overview of aspects of the present disclosure:

Aspect 1: A method for wireless communications at a UE, comprising: receiving a single control message scheduling a transmission burst comprising a plurality of downlink messages communicated in a plurality of downlink shared channels, the single control message indicating a first plurality of transmission configuration indicators associated with a first downlink shared channel of the plurality of downlink shared channels and a second plurality of transmission configuration indicators associated with a second downlink shared channel of the plurality of downlink shared channels; monitoring for a first downlink message of the plurality of downlink messages in the first downlink shared channel using a first transmission configuration indicator selected from the first plurality of transmission configuration indicators; and monitoring for a second downlink message of the plurality of downlink messages in the second downlink shared channel using a second transmission configuration indicator selected from the second plurality of transmission configuration indicators.

Aspect 2: The method of aspect 1, further comprising: monitoring the first downlink shared channel or a first control channel associated with the first downlink shared channel to determine a first channel quality metric; and monitoring the second downlink shared channel or a second control channel associated with the second downlink shared channel to determine a second channel quality metric; wherein the first transmission configuration indicator is selected for the first downlink shared channel based at least in part on the first channel quality metric, and wherein the second transmission configuration indicator is selected for the second downlink shared channel based at least in part on the second channel quality metric.

Aspect 3: The method of any of aspects 1 through 2, further comprising: receiving a second control message indicating that the UE is to use the second transmission configuration indicator to monitor for the second downlink message; wherein the second downlink shared channel is monitored using the second transmission configuration indicator based at least in part on the second control message.

Aspect 4: The method of any of aspects 1 through 3, further comprising: transmitting one or more negative acknowledgement messages associated with failure to receive the first downlink message via the first downlink shared channel; and receiving, based at least in part on transmitting the one or more negative acknowledgement messages, a second control message indicating that the UE is to monitor for the second downlink message in the second downlink shared channel using the second transmission configuration indicator.

Aspect 5: The method of any of aspects 1 through 4, further comprising: transmitting one or more negative acknowledgement messages associated with failure to receive the first downlink message via the first downlink shared channel; and monitoring for the second downlink message in the second downlink shared channel using the second transmission configuration indicator based at least in part on a quantity of the one or more negative acknowledgement messages being greater than or equal to a negative acknowledgement message quantity threshold.

Aspect 6: The method of any of aspects 1 through 5, further comprising: receiving the single control message indicating a first feedback offset value and a second feedback offset value; wherein the first downlink shared channel is monitored using the first transmission configuration indicator based at least in part on the first feedback offset value, and wherein the second downlink shared channel is monitored using the second transmission configuration indicator based at least in part on the second feedback offset value.

Aspect 7: A method for wireless communications at a UE, comprising: receiving a single control message scheduling a transmission burst comprising a plurality of uplink messages communicated in a plurality of uplink shared channels, the single control message indicating to apply a first precoding matrix for transmission of the plurality of uplink messages; precoding, using a second precoding matrix that is different than the first precoding matrix, a first uplink message of the plurality of uplink messages to generate a precoded first uplink message; and transmitting the precoded first uplink message in a first uplink shared channel of the plurality of uplink shared channels.

Aspect 8: The method of aspect 7, further comprising: precoding the first uplink message using the second precoding matrix based at least in part on an expiry of a timer relative to receipt of the single control message.

Aspect 9: The method of aspect 8, further comprising: receiving a second control message indicating a time threshold at which the timer is to expire.

Aspect 10: The method of any of aspects 8 through 9, further comprising: starting the timer at a first time corresponding with a first slot of a first-in-time uplink message of the plurality of uplink messages or at a second time corresponding to a beginning of connected mode discontinuous reception operation of the UE.

Aspect 11: The method of any of aspects 7 through 10, further comprising: receiving a plurality of negative acknowledgement messages associated with one or more uplink messages of the plurality of uplink messages; and precoding the first uplink message using the second precoding matrix based at least in part on a quantity of the plurality of negative acknowledgement messages being greater than or equal to a negative acknowledgement message quantity threshold.

Aspect 12: The method of aspect 11, further comprising: receiving a second control message indicating the negative acknowledgement message quantity threshold.

Aspect 13: The method of any of aspects 7 through 12, further comprising: transmitting an uplink control message indicating that the first uplink message is to be precoded using the second precoding matrix.

Aspect 14: The method of aspect 13, further comprising: transmitting the precoded first uplink message using a first transmission configuration indicator based at least in part on one or more indications of channel quality of the first uplink shared channel.

Aspect 15: The method of any of aspects 13 through 14, wherein the uplink control message is multiplexed with an uplink message of the plurality of uplink messages.

Aspect 16: The method of any of aspects 7 through 15, wherein the second precoding matrix is selected from a plurality of precoding matrices permitted to be used by the UE.

Aspect 17: An apparatus for wireless communications at a UE, comprising a processor; memory coupled with the processor; and instructions stored in the memory and executable by the processor to cause the apparatus to perform a method of any of aspects 1 through 6.

Aspect 18: An apparatus for wireless communications at a UE, comprising at least one means for performing a method of any of aspects 1 through 6.

Aspect 19: A non-transitory computer-readable medium storing code for wireless communications at a UE, the code comprising instructions executable by a processor to perform a method of any of aspects 1 through 6.

Aspect 20: An apparatus for wireless communications at a UE, comprising a processor; memory coupled with the processor; and instructions stored in the memory and executable by the processor to cause the apparatus to perform a method of any of aspects 7 through 16.

Aspect 21: An apparatus for wireless communications at a UE, comprising at least one means for performing a method of any of aspects 7 through 16.

Aspect 22: A non-transitory computer-readable medium storing code for wireless communications at a UE, the code comprising instructions executable by a processor to perform a method of any of aspects 7 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a single control message scheduling a transmission burst comprising a plurality of downlink messages communicated in a plurality of downlink shared channels, the single control message indicating a first plurality of transmission configuration indicators associated with a first downlink shared channel of the plurality of downlink shared channels and a second plurality of transmission configuration indicators associated with a second downlink shared channel of the plurality of downlink shared channels;
monitor for a first downlink message of the plurality of downlink messages in the first downlink shared channel using a first transmission configuration indicator selected from the first plurality of transmission configuration indicators; and
monitor for a second downlink message of the plurality of downlink messages in the second downlink shared channel using a second transmission configuration indicator selected from the second plurality of transmission configuration indicators.

2. The apparatus of claim 1, wherein the instructions are further executable by the processor to cause the apparatus to:
monitor the first downlink shared channel or a first control channel associated with the first downlink shared channel to determine a first channel quality metric; and
monitor the second downlink shared channel or a second control channel associated with the second downlink shared channel to determine a second channel quality metric;
wherein the first transmission configuration indicator is selected for the first downlink shared channel based at least in part on the first channel quality metric, and wherein the second transmission configuration indicator is selected for the second downlink shared channel based at least in part on the second channel quality metric.

3. The apparatus of claim 1, wherein the instructions are further executable by the processor to cause the apparatus to:
receive a second control message indicating that the UE is to use the second transmission configuration indicator to monitor for the second downlink message;
wherein the second downlink shared channel is monitored using the second transmission configuration indicator based at least in part on the second control message.

4. The apparatus of claim 1, wherein the instructions are further executable by the processor to cause the apparatus to:
transmit one or more negative acknowledgement messages associated with failure to receive the first downlink message via the first downlink shared channel; and
receive, based at least in part on the transmission of the one or more negative acknowledgement messages, a second control message indicating that the UE is to monitor for the second downlink message in the second downlink shared channel using the second transmission configuration indicator.

5. The apparatus of claim 1, wherein the instructions are further executable by the processor to cause the apparatus to:
transmit one or more negative acknowledgement messages associated with failure to receive the first downlink message via the first downlink shared channel; and
monitor for the second downlink message in the second downlink shared channel using the second transmission configuration indicator based at least in part on a quantity of the one or more negative acknowledgement messages being greater than or equal to a negative acknowledgement message quantity threshold.

6. The apparatus of claim 1, wherein the instructions are further executable by the processor to cause the apparatus to:
receive the single control message indicating a first feedback offset value and a second feedback offset value;
wherein the first downlink shared channel is monitored using the first transmission configuration indicator based at least in part on the first feedback offset value, and wherein the second downlink shared channel is monitored using the second transmission configuration indicator based at least in part on the second feedback offset value.

7. An apparatus for wireless communications at a user equipment (UE), comprising:
a processor;
memory coupled with the processor; and
instructions stored in the memory and executable by the processor to cause the apparatus to:
receive a single control message scheduling a transmission burst comprising a plurality of uplink messages communicated in a plurality of uplink shared channels, the single control message indicating to apply a first precoding matrix for transmission of the plurality of uplink messages;
precode, using a second precoding matrix that is different than the first precoding matrix, a first uplink message of the plurality of uplink messages to generate a precoded first uplink message; and
transmit the precoded first uplink message in a first uplink shared channel of the plurality of uplink shared channels.

8. The apparatus of claim 7, wherein the instructions are further executable by the processor to cause the apparatus to:
precode the first uplink message using the second precoding matrix based at least in part on an expiry of a timer relative to receipt of the single control message.

9. The apparatus of claim 8, wherein the instructions are further executable by the processor to cause the apparatus to:
receive a second control message indicating a time threshold at which the timer is to expire.

10. The apparatus of claim 8, wherein the instructions are further executable by the processor to cause the apparatus to:
start the timer at a first time corresponding with a first slot of a first-in-time uplink message of the plurality of uplink messages or at a second time corresponding to a beginning of connected mode discontinuous reception operation of the UE.

11. The apparatus of claim 7, wherein the instructions are further executable by the processor to cause the apparatus to:
receive a plurality of negative acknowledgement messages associated with one or more uplink messages of the plurality of uplink messages; and
precode the first uplink message using the second precoding matrix based at least in part on a quantity of the plurality of negative acknowledgement messages being greater than or equal to a negative acknowledgement message quantity threshold.

12. The apparatus of claim 11, wherein the instructions are further executable by the processor to cause the apparatus to:
receive a second control message indicating the negative acknowledgement message quantity threshold.

13. The apparatus of claim 7, wherein the instructions are further executable by the processor to cause the apparatus to:
transmit an uplink control message indicating that the first uplink message is to be precoded using the second precoding matrix.

14. The apparatus of claim 13, wherein the instructions are further executable by the processor to cause the apparatus to:
transmit the precoded first uplink message using a first transmission configuration indicator based at least in part on one or more indications of channel quality of the first uplink shared channel.

15. The apparatus of claim 13, wherein the uplink control message is multiplexed with an uplink message of the plurality of uplink messages.

16. The apparatus of claim 7, wherein the second precoding matrix is selected from a plurality of precoding matrices permitted to be used by the UE.

17. A method for wireless communications at a user equipment (UE), comprising:
receiving a single control message scheduling a transmission burst comprising a plurality of downlink messages communicated in a plurality of downlink shared channels, the single control message indicating a first plurality of transmission configuration indicators associated with a first downlink shared channel of the plurality of downlink shared channels and a second plurality of transmission configuration indicators associated with a second downlink shared channel of the plurality of downlink shared channels;
monitoring for a first downlink message of the plurality of downlink messages in the first downlink shared channel using a first transmission configuration indicator selected from the first plurality of transmission configuration indicators; and
monitoring for a second downlink message of the plurality of downlink messages in the second downlink shared channel using a second transmission configuration indicator selected from the second plurality of transmission configuration indicators.

18. The method of claim 17, further comprising:
monitoring the first downlink shared channel or a first control channel associated with the first downlink shared channel to determine a first channel quality metric; and
monitoring the second downlink shared channel or a second control channel associated with the second downlink shared channel to determine a second channel quality metric;
wherein the first transmission configuration indicator is selected for the first downlink shared channel based at least in part on the first channel quality metric, and wherein the second transmission configuration indicator is selected for the second downlink shared channel based at least in part on the second channel quality metric.

19. The method of claim 17, further comprising:
receiving a second control message indicating that the UE is to use the second transmission configuration indicator to monitor for the second downlink message;
wherein the second downlink shared channel is monitored using the second transmission configuration indicator based at least in part on the second control message.

20. The method of claim 17, further comprising:
transmitting one or more negative acknowledgement messages associated with failure to receive the first downlink message via the first downlink shared channel; and
receiving, based at least in part on transmitting the one or more negative acknowledgement messages, a second control message indicating that the UE is to monitor for the second downlink message in the second downlink shared channel using the second transmission configuration indicator.

21. The method of claim 17, further comprising:
transmitting one or more negative acknowledgement messages associated with failure to receive the first downlink message via the first downlink shared channel; and
monitoring for the second downlink message in the second downlink shared channel using the second transmission configuration indicator based at least in part on a quantity of the one or more negative acknowledgement messages being greater than or equal to a negative acknowledgement message quantity threshold.

22. The method of claim 17, further comprising:
receiving the single control message indicating a first feedback offset value and a second feedback offset value;
wherein the first downlink shared channel is monitored using the first transmission configuration indicator based at least in part on the first feedback offset value, and wherein the second downlink shared channel is monitored using the second transmission configuration indicator based at least in part on the second feedback offset value.

23. A method for wireless communications at a user equipment (UE), comprising:
receiving a single control message scheduling a transmission burst comprising a plurality of uplink messages communicated in a plurality of uplink shared channels, the single control message indicating to apply a first precoding matrix for transmission of the plurality of uplink messages;
precoding, using a second precoding matrix that is different than the first precoding matrix, a first uplink message of the plurality of uplink messages to generate a precoded first uplink message; and
transmitting the precoded first uplink message in a first uplink shared channel of the plurality of uplink shared channels.

24. The method of claim 23, further comprising:
precoding the first uplink message using the second precoding matrix based at least in part on an expiry of a timer relative to receipt of the single control message.

25. The method of claim 24, further comprising:
receiving a second control message indicating a time threshold at which the timer is to expire.

26. The method of claim 24, further comprising:
starting the timer at a first time corresponding with a first slot of a first-in-time uplink message of the plurality of uplink messages or at a second time corresponding to a beginning of connected mode discontinuous reception operation of the UE.

27. The method of claim 23, further comprising:
receiving a plurality of negative acknowledgement messages associated with one or more uplink messages of the plurality of uplink messages; and
precoding the first uplink message using the second precoding matrix based at least in part on a quantity of the plurality of negative acknowledgement messages being greater than or equal to a negative acknowledgement message quantity threshold.

28. The method of claim 23, further comprising:
transmitting an uplink control message indicating that the first uplink message is to be precoded using the second precoding matrix.

29. The method of claim 28, further comprising:
transmitting the precoded first uplink message using a first transmission configuration indicator based at least in part on one or more indications of channel quality of the first uplink shared channel.

30. The method of claim 23, wherein the second precoding matrix is selected from a plurality of precoding matrices permitted to be used by the UE.
